(19) United States
(12) Patent Application Publication
(10) Pub. No.: US 2023/0047487 A1
(43) Pub. Date: Feb. 16, 2023

(54) DUAL COOLING FAN INTERPOSED BETWEEN MOTOR CONTROLLER AND MOTOR HOUSING

(71) Applicant: Nidec Motor Corporation, St. Louis, MO (US)

(72) Inventors: Michael Coles, Manlius, NY (US); Mark Lulling, Fort Wayne, IN (US); Justin Anteau, Fort Wayne, IN (US); Bruce Ley, Ossian, IN (US); Justin Mumaw, Fort Wayne, IN (US); Timothy H. Sullivan, Marcellus, NY (US); Brandon Bodeker, Fort Wayne, IN (US)

(73) Assignee: Nidec Motor Corporation, St. Louis, MO (US)

(21) Appl. No.: 17/399,851

(22) Filed: Aug. 11, 2021

(51) Int. Cl. H02K 9/10; H02K 5/04; H02K 11/38

(52) U.S. Cl. CPC H02K 9/10; H02K 5/04; H02K 11/38

(57) ABSTRACT

A motor assembly includes a motor, a controller, a fan, and a shroud. The motor includes a stator and a rotor rotatable about an axis. The controller is located axially from the motor and operable to at least in part control the motor. The fan is interposed axially between the stator and the controller. The fan is configured to propel a fluid. The shroud is configured to direct the fluid propelled by the fan in an axial direction.

### BACKGROUND OF THE INVENTION

### 1. Field of the Invention

The present invention relates generally to an electric motor assembly including a motor and a controller. The motor assembly further includes a cooling fan.

### 2. Discussion of the Prior Art

Electric motor assemblies conventionally include a motor and, in some instances, additionally include a controller. The controller may be disposed adjacent the motor (e.g., in axial alignment therewith) or remotely therefrom. Both the motor and the controller conventionally generate heat. A variety of conventional means of dissipating such heat are known, including but not limited to heat sinks, fins, and fluid flow.

### SUMMARY

According to one aspect of the present invention, a motor assembly comprises a motor, a controller, a fan, and a shroud. The motor includes a stator and a rotor rotatable about an axis. The controller is located axially from the motor and operable to at least in part control the motor. The fan is interposed axially between the stator and the controller. The fan is configured to propel a fluid. The shroud is configured to direct the fluid propelled by the fan in an axial direction.

Among other things, provision of a fan interposed axially between the stator and the controller and configured to propel a fluid, and of a shroud configured to direct the fluid propelled by the fan in an axial direction, facilitates shared transfer and dispersion of heat from the stator and the controller.

This summary is provided to introduce a selection of concepts in a simplified form. These concepts are further described below in the detailed description of the preferred embodiments. This summary is not intended to identify key features or essential features of the claimed subject matter, nor is it intended to be used to limit the scope of the claimed subject matter.

Various other aspects and advantages of the present invention will be apparent from the following detailed description of the preferred embodiments and the accompanying drawing figures.

### BRIEF DESCRIPTION OF THE DRAWING FIGURES

Preferred embodiments of the present invention are described in detail below with reference to the attached drawing figures, wherein:

FIG. 1 is a top perspective view of a motor assembly in accordance with a preferred embodiment of the present invention;

FIG. 2 is a bottom perspective view of the motor assembly of FIG. 1;

FIG. 3 is a partially exploded top perspective view of a portion of the motor assembly of FIGS. 1 and 2;

FIG. 4 is a partially sectioned top perspective view of the portion of the motor assembly shown in FIG. 3;

FIG. 5 is a partially sectioned side view of the portion of the motor assembly shown in FIGS. 3 and 4;

FIG. 6 is a partially sectioned side elevational view of the portion of the motor assembly shown in FIGS. 3-5;

FIG. 7 is a partially exploded top perspective view of the portion of the motor assembly shown in FIGS. 3-5, excluding the controller housing cap;

FIG. 8 is a partially exploded bottom perspective view of the portion of the motor assembly shown in FIG. 7;

FIG. 9 is an exploded top perspective view of the controller housing, shroud, fan cover, fan, and motor end head of the motor assembly of FIGS. 1-8;

FIG. 10 is an exploded bottom perspective view of the controller housing, shroud, fan cover, fan, and motor end head as shown in FIG. 9;

FIG. 11 is an enlarged, top perspective view of the controller housing and shroud of FIGS. 1-10;

FIG. 12 is bottom perspective view of the controller housing and shroud of FIG. 11;

FIG. 13 is a side perspective view of the controller housing and shroud of FIGS. 11 and 12;

FIG. 14 is an enlarged, top perspective view of the fan cover of FIGS. 1-10; and

FIG. 15 is a bottom perspective view of the fan cover of FIG. 14.

The drawing figures do not limit the present invention to the specific embodiments disclosed and described herein. While the drawings do not necessarily provide exact dimensions or tolerances for the illustrated structures or components, the drawings are to scale with respect to the relationships between the components of the structures illustrated in the drawings.

### DETAILED DESCRIPTION

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments.

Furthermore, unless specified or made clear, the directional references made herein with regard to the present invention and/or associated components (e.g., top, bottom, upper, lower, inner, outer, etc.) are used solely for the sake of convenience and should be understood only in relation to each other. For instance, a component might in practice be oriented such that faces referred to as “top” and “bottom” are sideways, angled, inverted, etc. relative to the chosen frame of reference.

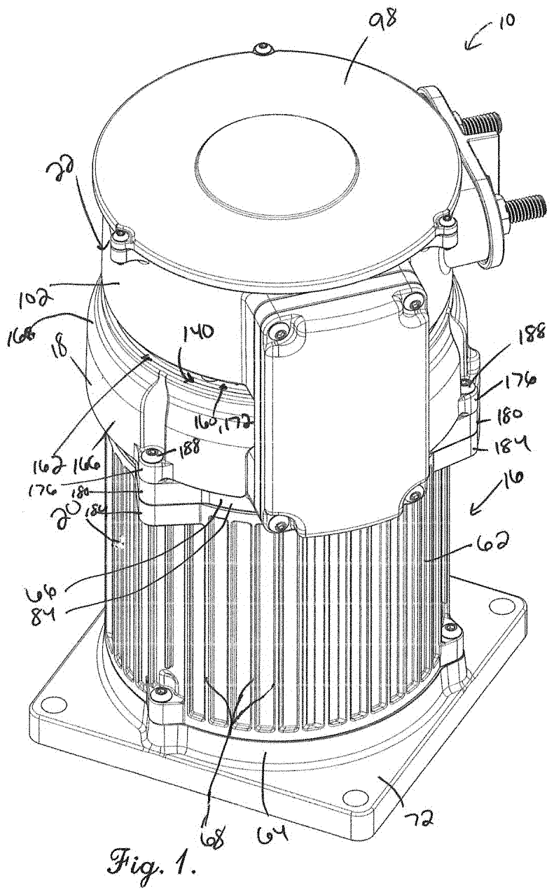

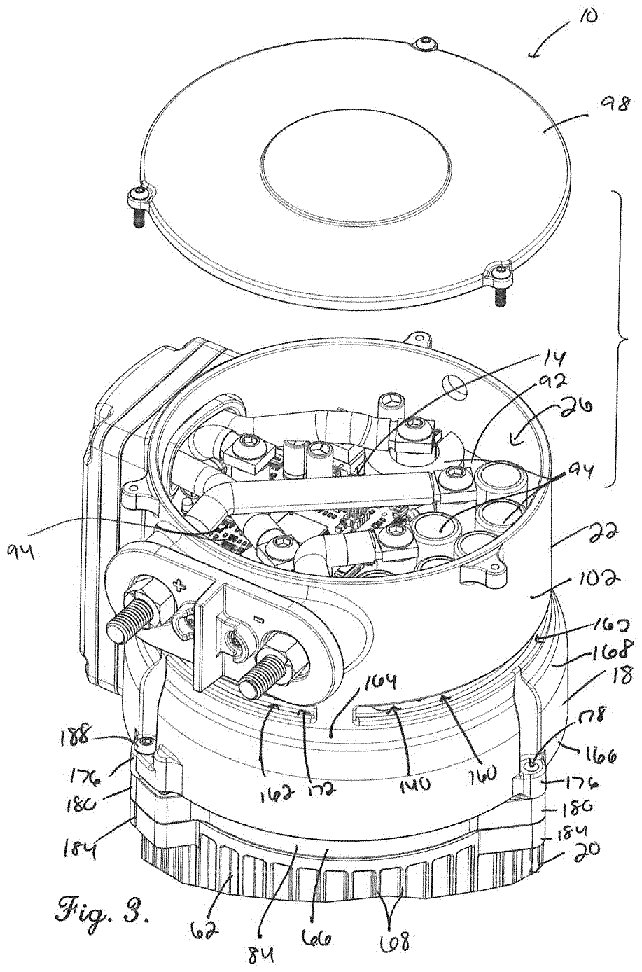

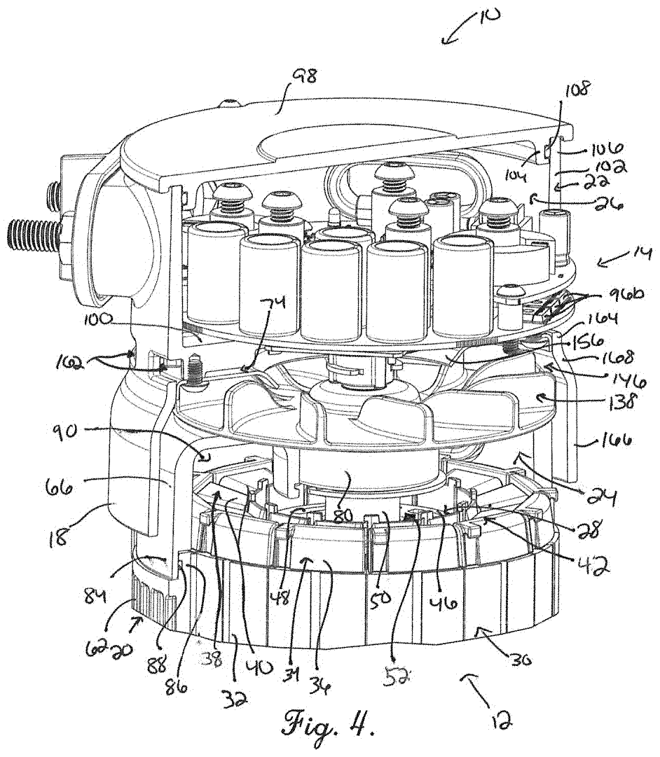

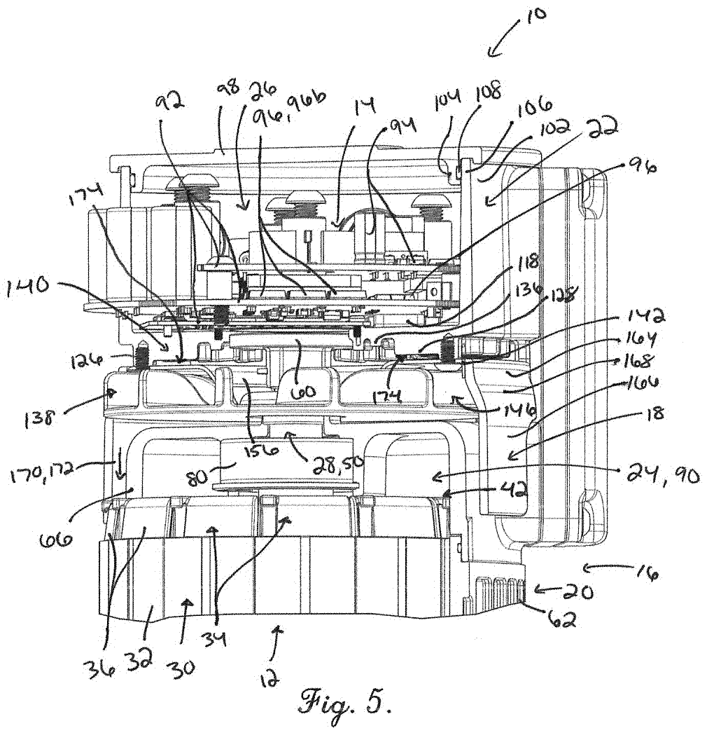

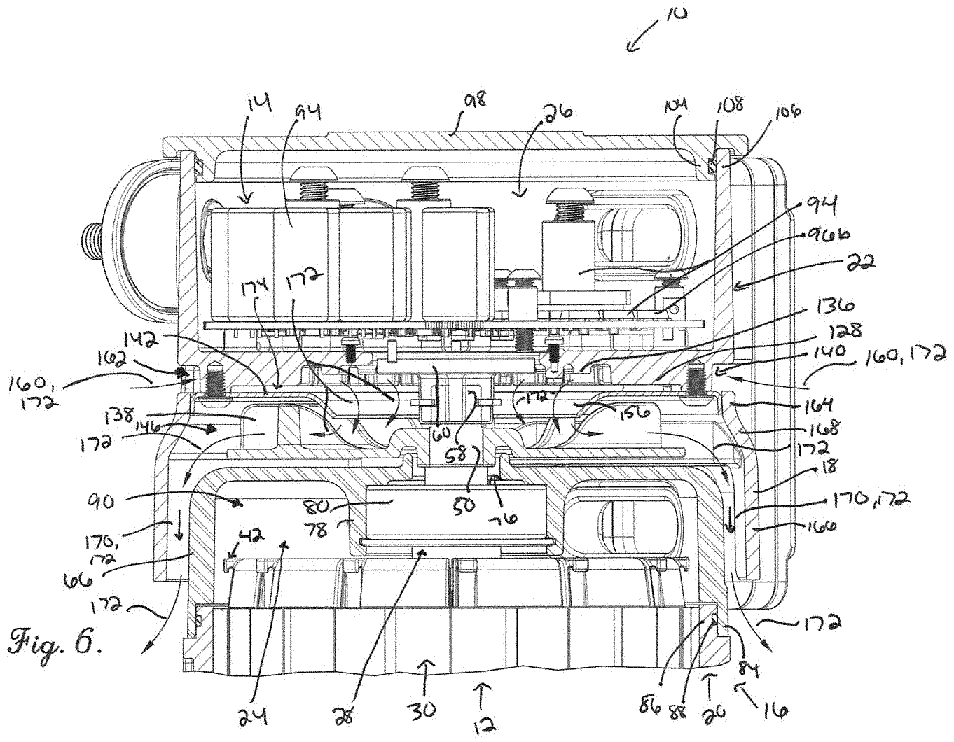

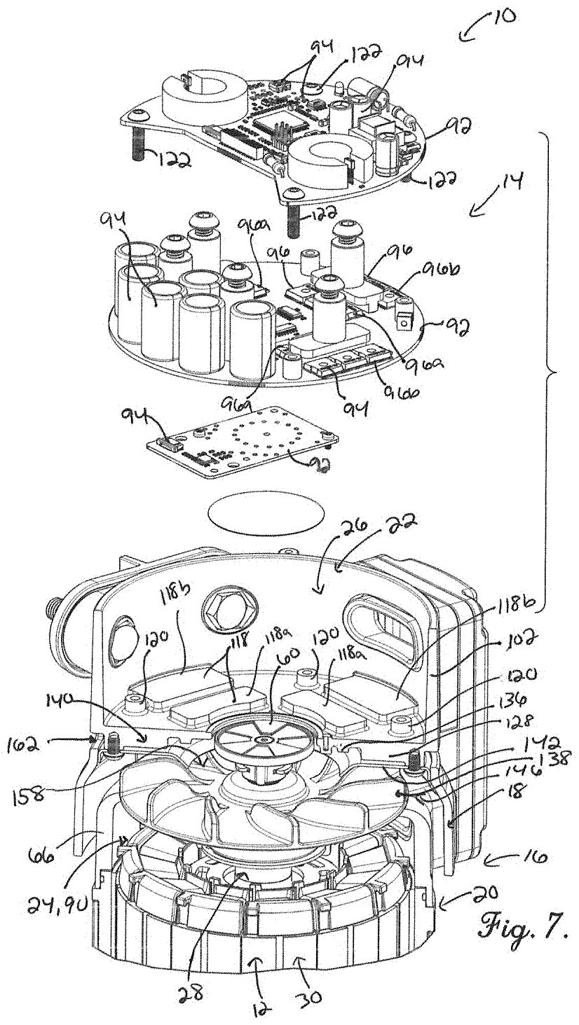

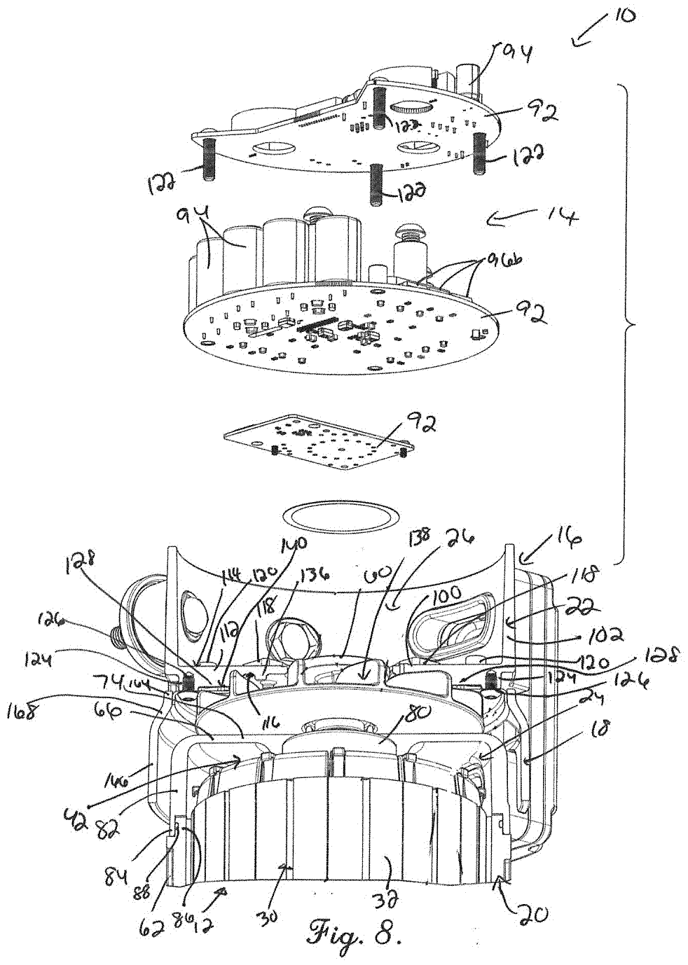

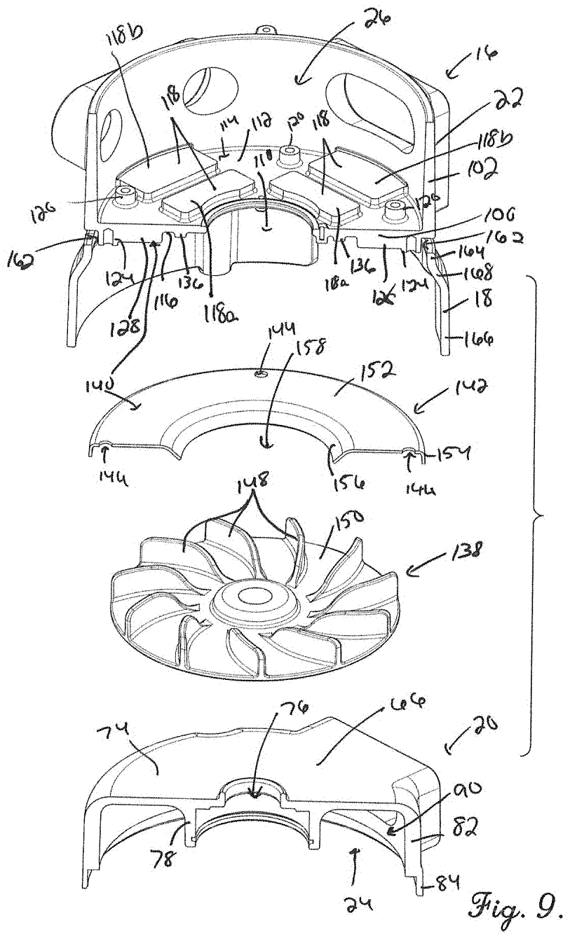

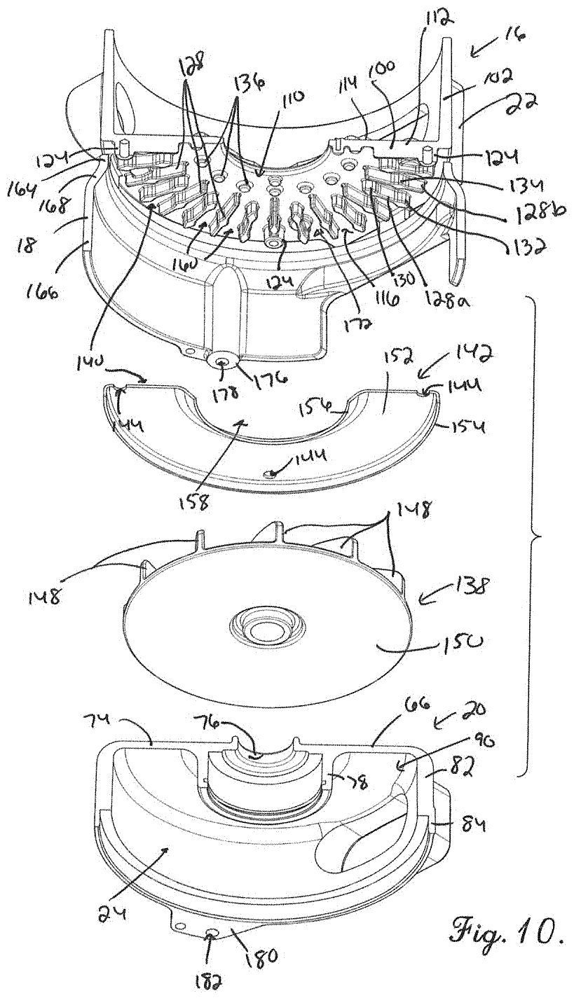

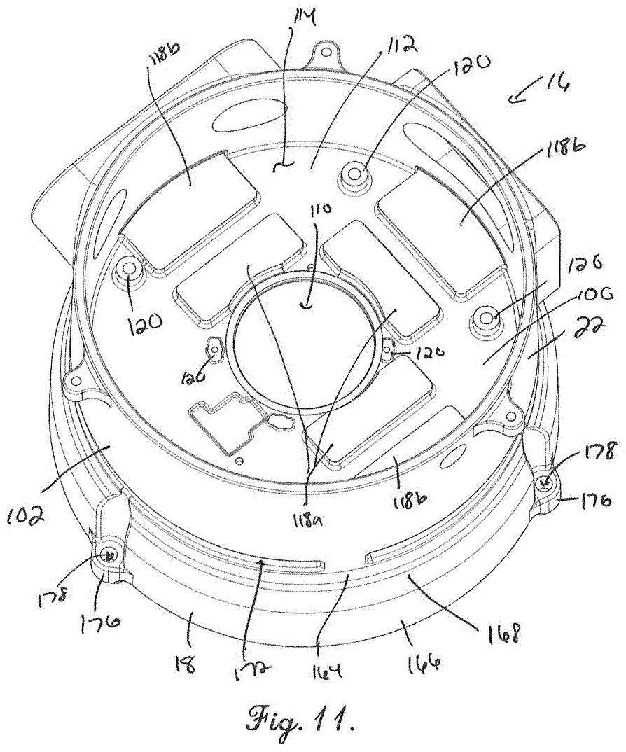

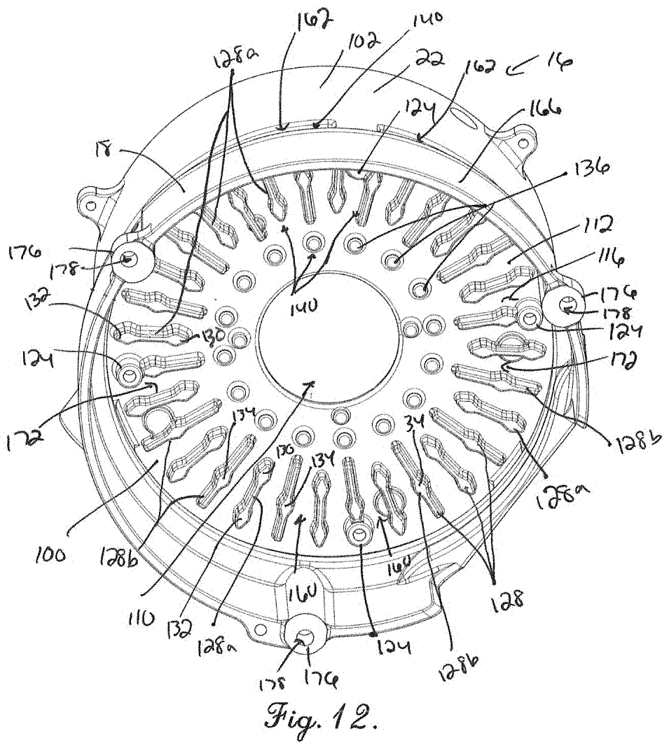

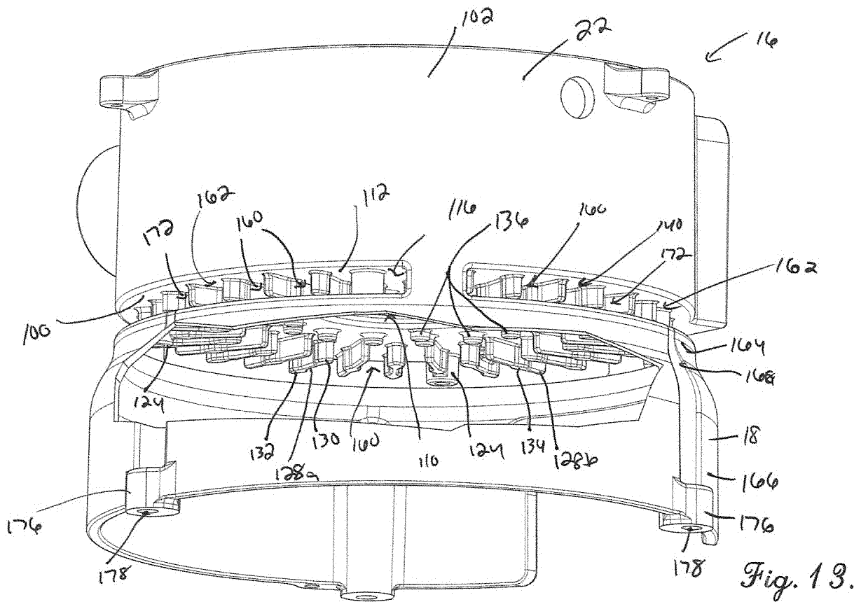

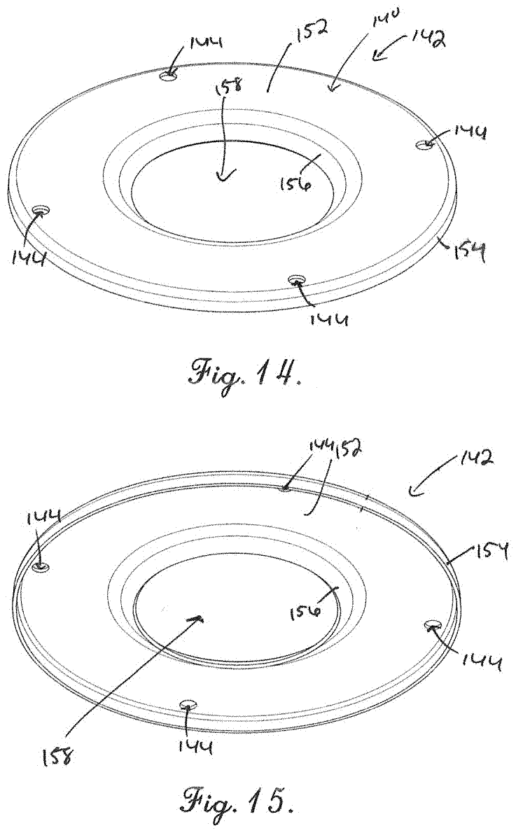

With initial reference to FIGS. 1-8, an electric motor assembly 10 is provided. The motor assembly 10 includes a motor 12, a controller 14, a housing 16, and a shroud 18. The housing 16 comprises a motor housing 20 and a controller housing 22. The motor housing 20 preferably at least in part defines a motor chamber 24 in which the motor 12 is at least substantially received. The controller housing 22 preferably at least in part defines a controller chamber 26 in which the controller 14 is at least substantially received.

The motor 12 includes a rotor 28 rotatable about an axis. The motor 12 further includes a stator 30. The stator 30 preferably at least substantially circumscribes the rotor 28 such that the motor 12 is an inner rotor motor. However, at least some of the inventive features described herein are equally applicable to outer rotor motors and/or dual rotor motors.

The stator 30 preferably includes a stator core 32 having a plurality of teeth (not shown), each of which is associated with a coil assembly 34. Each coil assembly 34 preferably includes a pair of electrically insulative endcaps 36 (positioned over the respective tooth) and a coil 38. Each coil 38 comprises electrically conductive wiring 40 wound about the respective endcaps 36.

Although the illustrated stator 30 is provided with endcaps 36, the stator may be insulated in any manner known in the art without departing from the scope of the present invention. For instance, the stator might be provided with overmolding, insulative inserts or wraps (e.g., Mylar papers), and/or bobbin-wound coils.

Furthermore, the stator 30 may be formed in any manner known in the art. For instance, the stator might be formed from punched linear bar laminations that are thereafter manipulated into curves, be a full round stator (i.e., comprising laminations punched in a full circle), be solidly constructed, be arcuately segmented, etc.

The stator 30 preferably defines an upper stator margin 42 and an axially opposed lower stator margin (not shown).

The rotor 28 preferably includes a rotor core 46, a plurality of magnets 48, and a shaft 50 defining a rotational axis for the rotor 28.

The rotor core 46 preferably comprises steel, although other materials may alternatively be used without departing from the scope of the present invention. The magnets 48 are preferably permanent magnets comprising ferrite, neodymium, or another suitable material.

The rotor core 46 preferably defines an upper rotor core margin 52 and an axially opposed lower rotor core margin (not shown), which are preferably but not necessarily disposed axially between the upper stator margin 42 and the lower stator margin (not shown).

The rotor shaft 50 preferably presents a drive end 56 (or lower end 56) configured to engage an element (not shown) to be powered by the motor 12. The rotor shaft 50 preferably extends downward past the lower stator and rotor core margins (not shown), such that the drive end 56 is disposed below the stator 30 and the rotor core 46.

The rotor shaft 50 further preferably includes an opposite drive end 58 (or upper end 58) axially opposed to the drive end 56. The rotor shaft 50 preferably extends upward past the upper stator and rotor core margins 42 and 52, respectively, such that the opposite drive end 58 is disposed above the stator 30 and the rotor core 46.

In the illustrated embodiment, the rotor 28 additionally includes a disc-like rotation sensor 60 mounted to the opposite drive end 58 of the rotor shaft 50, although such sensor may be omitted or replaced without departing from the scope of some aspects of the present invention.

As noted previously, the motor assembly 10 preferably includes the housing 16. The housing 16 includes the motor housing 20 and the controller housing 22. The motor housing 20 preferably includes a shell 62, an end shield 64 nearer the drive end 56, an end head 66 nearer the opposite drive end 58, and a shell 62 extending axially between and interconnecting the end shield 64 and the end head 66.

A plurality of axially extending rotor shell fins 68 preferably extend radially outwardly from the shell 62 and function as heat-dissipation devices to passively disperse heat generated by the motor 12.

The end shield 64 may be configured in any manner known in the art. Most preferably, however, the end shield 64 provides support for a motor bearing (not shown) and defines an opening 70 through which the drive end 56 of the rotor shaft 50 extends. In the illustrated embodiment, the end shield 64 also includes a mounting flange 72 to facilitate mounting on the motor assembly 10 as appropriate for a given application.

The motor end head 66 preferably includes a disc-like top 74 defining a radially inner opening 76 through which the opposite drive end 58 of the rotor shaft 50 extends.

The motor end head 66 further preferably includes a circumferential bearing seat 78 that receives a motor bearing 80.

Still further, the motor end head 66 preferably includes an at least substantially circumferential, axially downwardly extending outer wall 82. A portion 84 of the motor end head 66 preferably axially overlaps a portion 86 of the shell 62. Even more preferably, a seal 88 (such as an O-ring or grommet 88) is provided between the overlapping portions 84 and 86 to restrict ingress of contaminants into the motor chamber 24. Other types of connections and/or seals, including non-sealed configurations, are permissible according to some aspects of the present invention, however.

The motor chamber 24 is in part spatially filled by the stator 30, the rotor 28, the upper bearing 80, and the lower bearing (not shown). However, an unobstructed or at least substantially unobstructed lower space (not shown) preferably remains, primarily between the end shield 64 and the lower margins (not shown) of the stator 30 and rotor core 46, respectively. Furthermore, an unobstructed or at least substantially unobstructed upper space 90 preferably remains primarily between the motor end head 66 and the upper margins 42 and 52 of the stator 30 and the rotor core 46, respectively.

As will be understood by those of ordinary skill in the art, operation of the motor 12 results in generation of heat. Some of such heat will conductively transferred to the aforementioned motor shell fins 68, while some of such heat will be initially contained in each of the upper space 90 and lower space (not shown). The means by which such heat is dissipated, particularly with respect to the upper space 90, will be discussed in greater detail below.

As noted previously, the motor assembly 10 preferably includes the controller 14, which is at least substantially housed within the controller housing 22. The controller 14 preferably includes a plurality of printed circuit boards 92 and electronic components 94 mounted to respective ones of the printed circuit boards 92. The electronic components 94 may be of any type. In the illustrated embodiment, however, it is particularly noted that a plurality of transformers 96 (more particularly, a plurality of metal-oxide-semiconductor field-effect transistors 96, or MOSFETS 96) are provided.

The controller housing 22 preferably includes a plate-like top or lid 98, a base 100 axially opposite the top 98, and a circumferential sidewall 102 extending between and interconnecting the top 98 and the base 100.

In a preferred embodiment, the top 98 includes a circumferential, axially downwardly extending lip 104. The lip 104 overlaps an upper portion 106 of the sidewall 102. Even more preferably, a seal 108 (such as an O-ring or grommet 108) is provided between the lip 104 and the upper sidewall portion 106 to restrict ingress of contaminants into the motor chamber 24. Other types of connections and/or seals, including non-sealed configurations, are permissible according to some aspects of the present invention, however.

The base 100 is preferably generally toroidal in form to define a central opening 110. The sensor 60 is preferably positioned in or near the opening 110 to be readily sensed therethrough by one or more components of the controller 14.

The base 100 preferably includes a plate-like main body 112 presenting axially opposed upper and lower surfaces 114 and 116, respectively. A plurality of heat sinks 118 project axially upwardly from the upper surface 114. The heat sinks 118 preferably correspond to and are positioned axially below respective sets of the MOSFETS 96. For instance, in the illustrated embodiment, three (3) arcuately spaced apart sets of radially inner and outer heat sinks 118a and 118b are provided in correspondence with three (3) arcuately spaced apart sets of radially inner and outer MOFETS 96a and 96b.

It is noted, however, that more or fewer heat sinks and/or MOSFETS might be provided, and that some or all of the heat sinks might not correspond with MOSFETS. For instance, additional heat sinks might be provided in association with other electronic components, sets of radially inner and outer MOSFETS might be associated with a common, larger heat sink, etc. Ultimately, however, presence of at least some structural elements configured to conductively transfer heat from the controller 14 to the controller housing 22 is preferred.

A plurality of fastener-receiving bosses 120 preferably extend axially upwardly from the upper surface 114. The bosses 120 receive corresponding fasteners 122 extending through the controller 14 to secure the controller 14 to the controller housing 22. Other attachment means, including but not limited to latches, adhesives, and so on, may additionally or alternatively be used, however.

A second plurality of fastener-receiving bosses 124 preferably extend axially downwardly from the lower surface 116. The bosses 124 receive corresponding fasteners 126, the function of which will be described in greater detail below.

In a preferred embodiment, as illustrated, a plurality of arcuately spaced apart, radially extending fins 128 project axially downwardly from the lower surface 116. The fins 128 are preferably of two (2) designs. More particularly, the fins 128a of a first set include radially opposed inner and outer bulbous portions 130 and 132, respectively. The fins 128b of a second set are arcuately interposed between the first-style fins 128a and each include a radially intermediate bulbous portion 134.

A plurality of arcuately spaced apart nodules 136 also project axially downwardly from the lower surface 116. The nodules 136 in the illustrated embodiment each correspond with a fin 128b of the second set and are radially aligned therewith. However, alternative positioning and/or correspondence (e.g., with the fins of the first set) falls within the scope of some aspects of the present invention.

As will be discussed in greater detail below, the motor assembly 12 further preferably includes a fan 138 and fan inlet structure 140. The fan 138 is preferably mounted to the opposite drive end 58 of the rotor shaft 50 so as to be interposed axially between the stator 30 and the controller 14. More particularly, the fan 138 is disposed axially above the motor end head 66 (i.e., above the upper margins 42 and 52 of the stator 30 and the rotor core 46, respectively) and axially below the base 100 of the controller housing 22. Alternatively stated, the main body 112 of the base 100 of the controller housing 22 and the top 74 of the motor end head 66 preferably at least in part define a fan chamber 146 in which the fan 138 is received.

In a broad sense and as will be discussed in greater detail below, the fan 138 of the present invention is configured to generate fluid flow to convectively remove heat from the motor assembly 10. More particularly, the fan 138 is configured to propel a fluid, such as air. In greater detail still, the fan 138 preferably includes a plurality of arcuately spaced apart vanes 148 projecting axially upwardly from a main body 150. However, any of a variety of fan configurations fall within the scope of some aspects of the present invention.

A fan cover 142 is preferably fixed to the controller housing 22 so as to be positioned axially between the fan 138 and the controller housing 22. More particularly, the aforementioned fasteners 126 preferably extend through respective openings 144 in the fan cover 142 and are received in the bosses 124 of the controller housing 22. Other attachment means, including but not limited to latches, adhesives, and so on, may additionally or alternatively be used, however.

The fan cover 142 is preferably generally toroidal in form and includes a ceiling 152, a circumferentially outer rim 154 extending axially downward from the ceiling 152, and a radially inwardly and axially downwardly angled baffle 156 that defines a central opening 158. The function of the fan cover 142 will be discussed in greater detail below.

The fan inlet structure 140 is preferably configured to direct fluid radially through a portion of the motor assembly 12 prior to engagement with the fan 138. More particularly, the fan inlet structure 140 preferably defines a plurality of radial flow channels 160 in fluid communication with the environment and through which fluid is drawn into the fan 138.

In a preferred embodiment, the fan inlet structure 140 includes portions of both the controller housing 22 and the fan cover 142. For instance, pairs of arcuately adjacent fins 128a and 128b, in cooperation with the nodules 136, the lower surface 116 of the base 100 of the controller housing 22, and the ceiling 152 of the fan cover 142, cooperatively at least substantially define the radial flow channels 160 and are thus at least part of the fan inlet structure 142.

Furthermore, the sidewall 102 of the controller housing 22 defines a plurality of arcuate slits 162 therethrough that fluidly interconnect the flow channels 160 to the environment. (Portals or other designs, rather than the illustrated slits, might also be used without departing from the scope of some aspects of the present invention.)

In a preferred method of operation, rotation of the fan 138 as driven by the rotor 28 results in a radially inward draw of fluid from the environment (such fluid being air in the present exemplary method described herein), through the slits 162, and into the plurality of flow channels 160. As the air travels radially inwardly through the flow channels 160, heat generated by the controller 14 (e.g., by the MOSFETS 96) and transferred to the heat sinks 118, having been further conductively transferred to the fins 128 and nodules 136, is convectively “picked up” by the air.

The fan 138 thereafter draws the air axially downwardly, as guided by the baffle 156 of the fan cover 142, into a central region of the fan 138 before propelling such air radially outwardly.

As noted previously, the motor assembly 10 includes the shroud 18. The shroud 18 is preferably axially extending and generally cylindrical in form but includes an upper narrowed portion 164, a lower widened portion 166, and an intermediate transition or widening portion 168 extending between and interconnecting the narrowed and widened portions 164 and 166.

In a preferred embodiment, the narrowed portion 164 is disposed radially outward of and in axially overlapping engagement with the rim 154 of the fan cover 142. The transition portion 168 is preferably spaced radially outward of and in axial alignment with an at least substantial portion of the fan 138. The widened portion 166 is preferably spaced radially outward of and in axial alignment with at least a portion of the motor end head outer wall 82.

Thus, in a preferred embodiment, the transition portion 168 preferably at least in part defines the aforementioned fan chamber 146. Furthermore, as will be discussed in greater detail below, the widened portion 166 and the outer wall 82 of the motor end head 66 cooperatively at least in part define a flow path 170. The flow path 170 is preferably at least substantially cylindrical (in keeping with the preferred at least substantially cylindrical forms of both the outer wall 82 and the widened portion 166) and is furthermore most preferably unobstructed, except as described below.

In a preferred embodiment, as illustrated, the shroud 18 is integrally formed with the controller housing 22. That is, the controller housing 22 might alternatively be described as including the shroud 18. However, it is permissible according to some aspects of the present invention for the shroud to instead be non-integrally fixed (e.g., via fasteners, latches, welds, adhesives, etc.) to the controller housing or to be an entirely separate component supported via connection to another element (e.g., the motor end head).

Turning again to the exemplary method of operation described in part above, the air propelled radially outwardly by the fan 138 (after having previously been drawn radially inwardly through the flow channels 160 and guided axially downwardly by the baffle 156 into a central region of the fan 138) is most preferably propelled radially outwardly toward the transition portion 168 of the shroud 18. The shroud 18 and the outer wall 82 of the motor end head 66 thereafter guide the air axially downwardly along the motor end head 66 (i.e., through the flow path 170, external to the outer wall 82 and the motor chamber 24), during which time the air convectively “picks up” heat transferred to the motor end housing 16 from the space 90 in the motor chamber 24 (above the rotor core 46 and the stator 30).

The air thereafter flows externally along at least a portion of the motor housing shell 62, picking up thermal energy from the motor shell fins 68, and exits to the environment.

The air has thus removed heat generated by both the controller 14 and the motor 12 without flowing directly through either of the controller 14 and the motor 12.

It is noted that the slits 162, the flow channels 160, the flow path 170, and any associated intake, interconnecting, and/or discharge flow paths, channels, or regions cooperatively form a flow route 172 for cooling of the motor assembly 10.

In a preferred embodiment, the fins 128 of the controller housing 22 extend axially downward toward the fan cover 142 but do not make contact therewith, such that a plurality of gaps 174 are formed between the fins 128 and the fan cover 142. The gaps 174 facilitate flow/removal of any debris or contaminants without clogging or excessive obstruction of the aforementioned flow pattern.

It is also preferable that the controller housing 22 is conductively interconnected with the motor end head 66 and the motor housing 20 solely via a mounting structure associated with the shroud 18. More particularly, the shroud 18 includes a plurality of mounting bosses 176 defining corresponding fastener-receiving openings 178. The motor end head 66 includes a plurality of mounting bosses 180 defining corresponding fastener-receiving openings 182. The motor housing 20 likewise includes a plurality of mounting bosses 184 defining corresponding fastener-receiving openings (not shown).

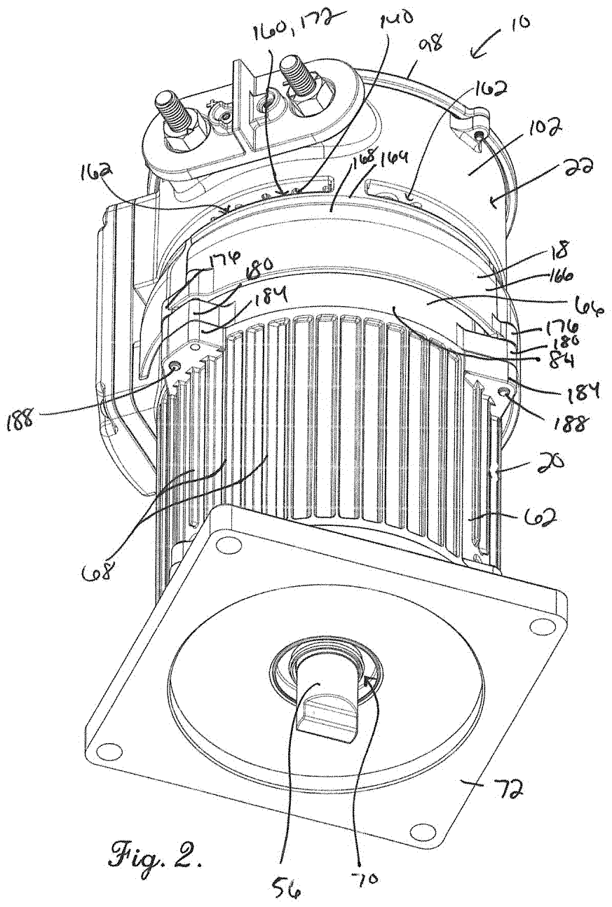

As best shown in FIGS. 1 and 2, the mounting bosses 176 of the shroud 18 are disposed axially above and at least in part in overlying relationship with corresponding ones of the mounting bosses 180 of the motor end head 66. Similarly, the mounting bosses 180 of the motor end head 66 are disposed axially above and at least in part in overlying relationship with corresponding ones of the mounting bosses 184 of the motor housing 20. Fasteners 188 extend through respective sets of openings 178 in the mounting bosses 176, openings 182 in the bosses 180, and openings (not shown) in the bosses 184.

The aforementioned mounting approach at least substantially minimizes direct (i.e., conductive) contact between elements bearing heat from the controller 14 (e.g., the controller housing 22 and the shroud 18) and elements bearing heat from the motor 12 (e.g., the motor end head 66 and the motor housing 20). That is, the motor 12 and the controller 14 are at least substantially thermally decoupled.

It is also noted that the contact between the shroud 18 and the motor housing 20 that does occur is positioned so as to be in the airstream and, more particularly, in the flow path 170 (e.g., rather than in the area between the motor end head and the controller).

The motor assembly 10 as described above is highly advantageous. Among other things, for instance, the motor assembly 10 efficiently and effectively manages thermal waste to maintain high performance. Such thermal management and consequent performance advantages are achieved without the use of long lead wires (e.g., as for a remotely positioned controller), without decreases to the controller envelope and/or the size of the printed circuit board(s) 92, and without added limits on the size of the heatsinks 118 for the MOSFETS 96. Rather, such thermal management and performance advantages are achieved through the use of shared active cooling of the motor 12 and the controller 14 by means of the fan 138, careful routing of cooling air through the flow channels 160 and the flow path 170, substantial thermal decoupling of the motor 12 and the controller 14 (or, alternatively stated, substantial isolation of the heat sources), and integral formation of the shroud 18 with the remainder of the controller housing 22.

Still further, the design of the present motor assembly 10 is such that labor content is reduced (e.g., assembly labor is reduced due to the combined motor/control design), a separate control vendor is unnecessary, less wiring is required, and the overall space required for the motor and controller is reduced (due to its integrated nature).

Although the present motor assembly 10 is well suited to a variety of applications, it is particularly noted that such motor assembly 10 might advantageously be associated with a boom truck, forklift, or other vehicle. For instance, the motor assembly 10 might operate a hydraulic pump for a forklift or alternatively be the primary power source for an aerial work platform (AWP).

Furthermore, the motor assembly 10 might be mounted to such vehicle (or another device) in such a manner as to facilitate additional thermal waste management (e.g., via use of the vehicle or device as an additional heatsink).

The preferred forms of the invention described above are to be used as illustration only and should not be utilized in a limiting sense in interpreting the scope of the present invention. Obvious modifications to the exemplary embodiments, as hereinabove set forth, could be readily made by those skilled in the art without departing from the spirit of the present invention.

Although the above description presents features of preferred embodiments of the present invention, other preferred embodiments may also be created in keeping with the principles of the invention. Furthermore, as noted previously, these other preferred embodiments may in some instances be realized through a combination of features compatible for use together despite having been presented independently as part of separate embodiments in the above description.

The inventors hereby state their intent to rely on the Doctrine of Equivalents to determine and access the reasonably fair scope of the present invention as pertains to any apparatus not materially departing from but outside the literal scope of the invention set forth in the following claims.

What is claimed is:

1. A motor assembly comprising:
a motor including a stator and a rotor rotatable about an axis;
a controller located axially from the motor and operable to at least in part control the motor;
a fan interposed axially between the stator and the controller,
said fan configured to propel a fluid; and
a shroud configured to direct the fluid propelled by the fan in an axial direction.

2. The motor assembly of claim 1,
said shroud configured to direct the fluid propelled by the fan axially away from the controller and toward the stator.

3. The motor assembly of claim 1, further comprising:
a controller housing,
said controller being at least substantially received within said controller housing,
said shroud being fixed to the controller housing.

4. The motor assembly of claim 3,
said shroud and said controller housing being integrally formed.

5. The motor assembly of claim 1, further including
fan inlet structure configured to direct the fluid radially through a portion of the motor assembly prior to engagement of the fluid with the fan.

6. The motor assembly of claim 5,
said motor assembly including a controller housing,
said controller being at least substantially received within said controller housing,
said controller housing at least in part defining the fan inlet structure.

7. The motor assembly of claim 6,
said controller housing including a plurality of arcuately spaced apart, axially projecting, radially extending fins,
said fins forming at least in part the fan inlet structure,
adjacent ones of said fins cooperatively at least in part defining a radially extending flow channel configured to direct the fluid through said portion of the motor assembly.

8. The motor assembly of claim 6, further comprising:
a fan cover interposed axially between the fan and the controller,
said fan cover forming part of the inlet structure.

9. The motor assembly of claim 8,
said fan cover being mounted to the controller housing.

10. The motor assembly of claim 8,
said fan cover including a baffle configured to direct fluid from the fan inlet structure at least in part axially toward the fan.

11. The motor assembly of claim 8,
said controller housing including a plurality of arcuately spaced apart, axially projecting, radially extending fins,
said fins forming at least in part the fan inlet structure,
adjacent ones of said fins cooperatively at least in part defining a radially extending flow channel configured to direct the fluid through said portion of the motor assembly,
said fan cover being spaced axially from the fins.

12. The motor assembly of claim 5, further comprising:
a controller housing,
said controller being at least substantially received within said controller housing,
said controller including a heat-generating component,
said controller housing including a heat sink in conductive thermal communication with the heat-generating component,
said heat sink being in thermal communication with the fluid in said portion of the motor assembly.

13. The motor assembly of claim 12,
said heat-generating component being a transistor.

14. The motor assembly of claim 1,
said fan configured to propel the fluid radially.

15. The motor assembly of claim 1, further comprising:
a controller housing; and
a motor housing,
said controller being at least substantially received within said controller housing,
said motor being at least substantially received within said motor housing,
said motor housing including an axially extending wall,
said shroud axially overlapping said axially extending wall and being radially spaced therefrom, such that an axially extending flow channel is formed therebetween.

16. The motor assembly of claim 15,
said axially extending wall at least in part defining a motor chamber,
said motor being at least substantially received in said motor chamber,
said flow channel extending external to the axially extending wall and the motor chamber.

17. The motor assembly of claim 15,
said axially extending wall and said shroud each being at least substantially cylindrical.

18. The motor assembly of claim 15,
said stator presenting first and second axially spaced apart stator ends,
said first stator end being disposed axially nearer to the fan than is the second stator end,
said motor housing including a motor end head at least in part disposed axially between the first stator end and the fan,
said motor end head including the axially extending wall,
said motor end head and said stator cooperatively at least in part defining a motor end chamber,
said shroud extending axially alongside and radially spaced from at least a portion of said motor end chamber.

19. The motor assembly of claim 15,
said controller housing including a plurality of controller housing flanges,
said motor housing including a plurality of motor housing flanges corresponding to said controller housing flanges,
said controller housing and said motor housing engaging one another exclusively at said controller housing flanges and said motor housing flanges so as to be at least substantially thermally decoupled.

20. The motor assembly of claim 1,
said controller including at least one printed circuit board,
said at least one printed circuit board being devoid of airflow channels therethrough.
